(19) United States
(12) Patent Application Publication
(10) Pub. No.: US 2024/0085273 A1
(43) Pub. Date: Mar. 14, 2024

(54) SYSTEMS AND METHODS FOR DETECTING BEARING FAILURES FOR DISK GANG ASSEMBLIES OF AGRICULTURAL IMPLEMENTS

(71) Applicant: CNH Industrial America LLC, New Holland, PA (US)

(72) Inventor: Brittany Schroeder, Bunker Hill, IN (US)

(21) Appl. No.: 17/940,124

(22) Filed: Sep. 8, 2022

(51) Int. Cl. G01M 13/045; A01B 35/16; A01B 79/00

(52) U.S. Cl. CPC G01M 13/045; A01B 35/16; A01B 79/005

(57) ABSTRACT

In one aspect, a system for detecting bearing failures for disk gang assemblies of an agricultural implement includes a disk gang assembly comprising a shaft assembly including a shaft and at least one bearing rotatably supporting the shaft. The disk gang assembly also includes a plurality of disks supported on the shaft for rotation therewith. The system also includes a sensor provided in operative association with the shaft assembly, with the sensor being configured to generate data indicative of a bearing-related parameter associated with the shaft assembly. Additionally, the system includes a computing system communicatively coupled to the sensor, with the computing system being configured to monitor the bearing-related parameter based at least in part on the data received from the sensor, and identify that the bearing(s) is experiencing a bearing failure condition based at least in part on an evaluation of the monitored bearing-related parameter.

### FIELD OF THE INVENTION

The present disclosure generally relates to agricultural implements and, more particularly, to systems and methods for detecting bearing failures for disk gang assemblies of an agricultural implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. Tillage implements typically include one or more tool assemblies configured to engage the soil as the implement is moved across the field. For example, in certain configurations, the implement may include one or more disk gang assemblies, leveling disk assemblies, rolling basket assemblies, shank assemblies, and/or the like. Such tool assemblies loosen and/or otherwise agitate the soil to prepare the field for subsequent planting operations.

Rotating tool assemblies, such as disk gang assemblies, basket assemblies, leveling disk assemblies, and the like, typically include one or more bearings that facilitate rotation of at least one component of the rotating tool assembly as an agricultural operation is being performed within the field. Over time, the bearing(s) of a given tool assembly will be subject to wear and tear, which can eventually result in failure of the bearing. Such bearing failures can result in the operation of the associated tool assembly being rendered ineffective or unsuitable for performing its intended function. However, it may be difficult for the operator to determine when a bearing failure has occurred relative to a given tool assembly.

Accordingly, systems and methods for detecting bearing failures associated with an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for detecting bearing failures for disk gang assemblies of an agricultural implement. The system includes a disk gang assembly comprising a shaft assembly including a shaft and at least one bearing rotatably supporting the shaft for rotation about a rotational axis. The disk gang assembly also includes a plurality of disks supported on the shaft for rotation therewith about the rotational axis. The system also includes a sensor provided in operative association with the shaft assembly, with the sensor being configured to generate data indicative of a bearing-related parameter associated with the shaft assembly. Additionally, the system includes a computing system communicatively coupled to the sensor, with the computing system being configured to monitor the bearing-related parameter associated with the shaft assembly based at least in part on the data received from the sensor, and identify that the at least one bearing is experiencing a bearing failure condition based at least in part on an evaluation of the monitored bearing-related parameter.

In another aspect, the present subject matter is directed to a method for detecting bearing failures for a disk gang assembly of an agricultural implement. The method includes monitoring, with a computing system, a bearing-related parameter associated with a shaft assembly of the disk gang assembly as the agricultural implement is being moved through a field during the performance of an agricultural operation, evaluating, with the computing system, the monitored bearing-related parameter relative to a predetermined threshold, and identifying, with the computing system, that at least one bearing of the shaft assembly is experiencing a bearing failure condition based at least in part on the evaluation of the monitored bearing-related parameter relative to the predetermined threshold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter, particularly illustrating the implement being towed by a work vehicle;

FIG. 2 illustrates another perspective view of the agricultural implement shown in FIG. 1 in accordance with aspects of the present subject matter;

FIG. 3 illustrates a front view of a portion of the agricultural implement shown in FIGS. 1 and 2, particularly illustrating portions of a disk gang assembly of the implement in accordance with aspects of the present subject matter;

FIG. 4 illustrates a schematic view of one embodiment of a system for detecting bearing failures for disk gang assemblies of an agricultural implement in accordance with aspects of the present subject matter;

FIG. 5 illustrates an example data plot showing monitored vibration data over time for a disk gang assembly of an agricultural implement, particularly illustrating an example in which the disk gang assembly is experiencing a bearing failure condition in accordance with aspects of the present subject matter; and

FIG. 6 illustrates a flow diagram of one embodiment of a method for detecting bearing failures for disk gang assemblies of an agricultural implement in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to systems and methods for detecting bearing failures for disk gang assemblies of an agricultural implement. In several embodiments, a computing system may be configured to monitor a parameter associated with a shaft assembly of a disk gang assembly that varies as a function of a condition of a bearing(s) of the shaft assembly, thereby allowing the computing system to determine or infer when the assembly is experiencing a bearing failure condition. Specifically, in one embodiment, the monitored “bearing-related parameter” may be compared to an applicable parameter threshold/range and, when the parameter differs from the threshold/range (e.g., by exceeding the threshold and/or by falling outside the range), the computing system may determine that at least one of the bearings of the corresponding disk gang assembly is experiencing a bearing failure condition. Upon making such a determination, the computing system may be configured to automatically initiate a control action, such as by generating an operator notification and/or automatically adjusting the operation of the implement.

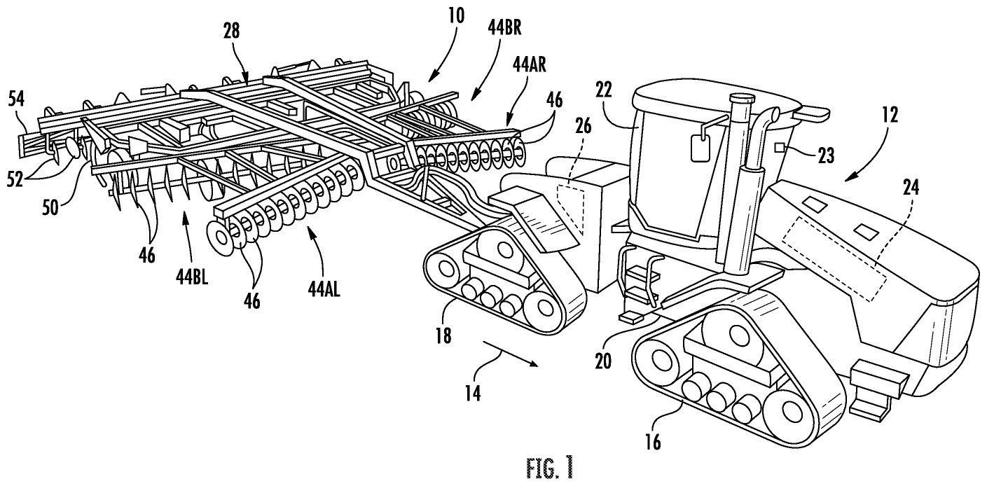

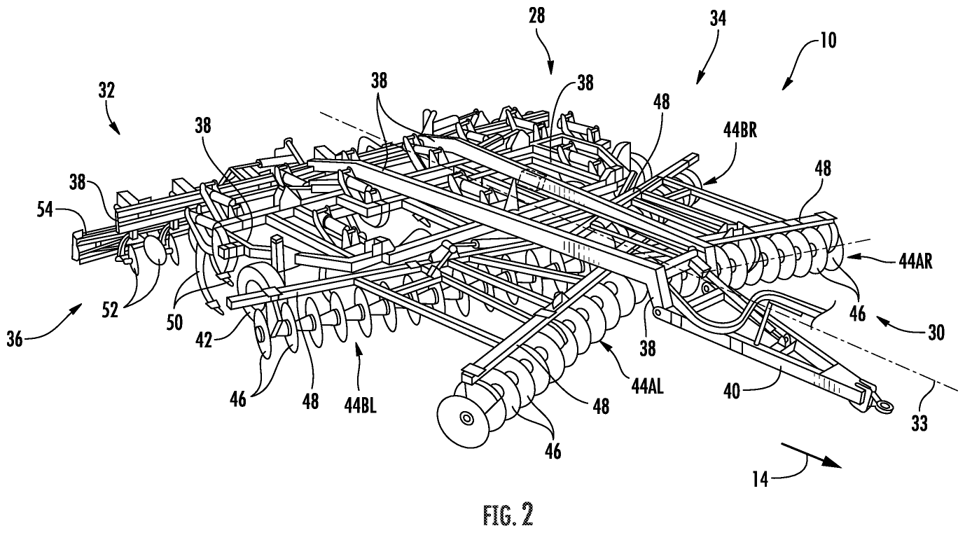

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14 in FIG. 1) by the work vehicle 12. As shown, the implement 10 may be configured as a tillage implement, and the work vehicle 12 may be configured as an agricultural tractor. In other embodiments, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair of rear track assemblies 18, and a frame or chassis 20 coupled to and supported by the track assemblies 16, 18. Alternatively, the track assemblies 16, 18 can be replaced with tires or any other suitable traction members. An operator's cab 22 may be supported by a portion of the chassis 20 and may house various input devices (e.g., a user interface 23) for permitting an operator to control the operation of one or more components of the work vehicle 12 and/or one or more components of the implement 10. Additionally, as is generally understood, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first lateral side 34 (e.g., a right side of the implement 10) and a second lateral side 36 (e.g., a left side of the implement 10), with a longitudinal centerline 33 of the implement frame 28 extending in the longitudinal direction between the forward and aft ends 30, 32 and generally dividing the first lateral side 34 from the second lateral side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (one is shown in FIG. 2) may be coupled to the frame 28 to facilitate towing the implement 10 in the direction of travel 14.

In several embodiments, the frame 28 may be configured to support one or more disk gang assemblies 44. As illustrated in FIG. 2, each disk gang assembly 44 includes a toolbar 48 coupled to the implement frame 28 and a plurality of harrow disks 46 supported by the toolbar 48 relative to the implement frame 28. Each harrow disk 46 may, in turn, be configured to penetrate into or otherwise engage the soil as the implement 10 is being pulled through the field. As is generally understood, the various disk gang assemblies 44 may be oriented at an angle relative to the direction of travel 14 to promote more effective tilling of the soil. In the embodiment shown in FIGS. 1 and 2, the implement 10 includes four disk gang assemblies 44 supported relative to the frame 28 at a location forward of the remainder of the ground-engaging tools. Specifically, the implement 10 includes a pair of front disk gang assemblies 44A (e.g., a left front disk gang assembly 44AL and a right front disk gang assembly 44AR) and a pair of rear disk gang assemblies 44B (e.g., a left rear disk gang assembly 44BL and a right rear disk gang assembly 44BR) positioned aft or rearward of the front disk gang assemblies 44A relative to the direction of travel 14 of the implement 10, with the right-side disk gang assemblies 44AR, 44BR being positioned on the right or first lateral side 34 of the implement 10 and the left-side disk gang assemblies 44AL, 44BL being positioned on the left or second lateral side 36 of the implement 10. It should be appreciated that, in alternative embodiments, the implement 10 may include any other suitable number of disk gang assemblies 44, such as more or less than four disk gang assemblies 44. Furthermore, in one embodiment, the disk gang assemblies 44 may be mounted to the frame 28 at any other suitable location, such as adjacent to its aft end 32.

Additionally, as shown, in one embodiment, the implement frame 28 may be configured to support other ground-engaging tool assemblies. In the illustrated embodiment, the frame 28 is also configured to support one or more finishing tool assemblies, such as a plurality of leveler disk assemblies 52 and/or rolling (or crumbler) basket assemblies 54. However, in other embodiments, any other suitable ground-engaging tool assemblies may be coupled to and supported by the implement frame 28, such as a plurality of closing disks.

It should be appreciated that the configuration of the implement 10 described above and shown in FIGS. 1 and 2 is provided only to place the present subject matter in an exemplary field of use. Thus, it should be appreciated that the present subject matter may be readily adaptable to any manner of implement configurations.

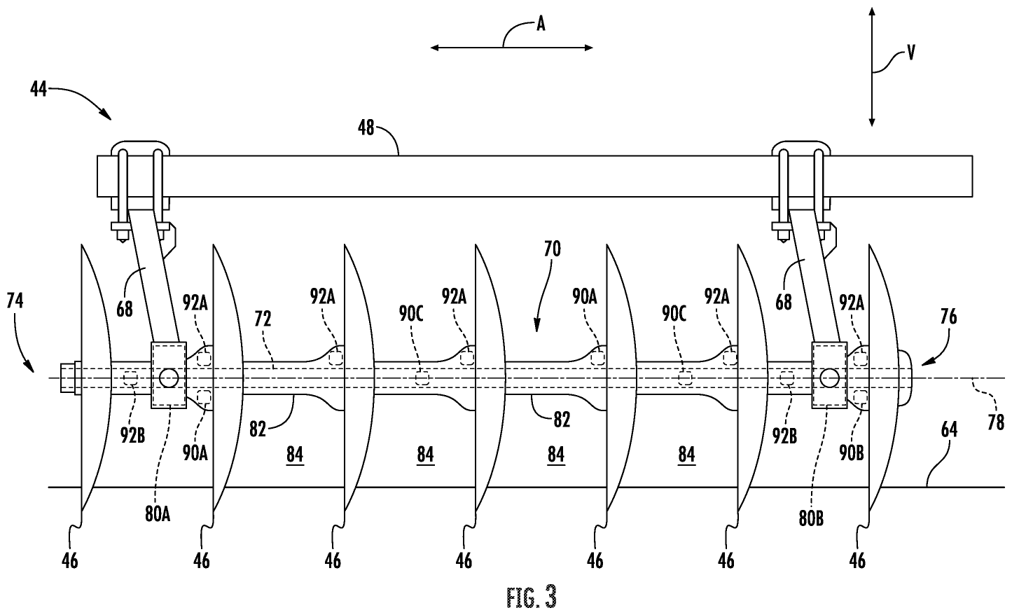

Referring now to FIG. 3, a front view of a portion of the implement 10 described above with reference to FIGS. 1 and 2 is illustrated in accordance with aspects of the present subject matter, particularly illustrating a front view of one of the disk gang assemblies 44 of the implement 10. As indicated above, each disk gang assembly 44 may include a plurality of harrow disks 46 supported relative to a toolbar 48, such as via a plurality of hangers 68 (e.g., C-hangers). The toolbar 48 of each disk gang assembly 44 is, in turn, configured to be coupled to the implement frame 28.

In several embodiments, the disk gang assembly 44 may also include a shaft assembly 70 for rotatably supporting the disks 46 relative to the toolbar 48 and associated hangers 68. As shown in FIG. 3, in one embodiment, the shaft assembly 70 may include a gang shaft (e.g., as indicated with dashed lines 72) that extends along an axial direction of the disk gang assembly 44 (e.g., as indicated by arrow A) between a first end 74 and a second end 76. The gang shaft 70 may be positioned below the toolbar 48 of the disk gang assembly 44 along a vertical direction (e.g., as indicated by arrow V) of the implement 10 and supported relative to the toolbar 48 via the hangers 68. However, in alternative embodiments, the disk gang shaft 72 may have any other suitable orientation.

Each disk 46 may be rotatably coupled or keyed to the gang shaft 72 such that the shaft 72 and disks 46 rotate together about a rotational axis (e.g., as indicated by dashed line 78) of the disk gang assembly 44. To facilitate such rotation of the shaft/disks 72, 46 relative to the hangers 68, a bearing 80 may be provided between the shaft 72 and each hanger 68 to provide a rotational interface there-between. For instance, as shown in FIG. 3, a first bearing 80A may be provided between the shaft 72 and one of the hangers 68 and a second bearing 80B may be provided between the shaft 72 and the other hanger 68. In one embodiment, an outer race of each bearing 80 may be coupled to the adjacent hanger 68 and an inner race of the bearing 80 may be coupled to the shaft 72, with the inner race being configured to rotate relative to the outer race to allow the shaft 72 to rotate relative to the hanger 68.

Additionally, the shaft assembly 70 may also include a plurality of spools 82 positioned on the gang shaft 72, with each spool 82 extending axially between a pair of adjacent disks 46. For instance, as shown in FIG. 3, each disk 46 is spaced apart from an adjacent disk 46 in the axial direction A via a respective spool 82 extending therebetween along the adjacent axial section of the gang shaft 72. As a result, an open space 84 is defined between each pair of adjacent disks 46 in the axial direction A via the spacing provided by the associated spool 82.

With the disk gang assembly 44 positioned at its lowered or working position, the disks 46 of the assembly 44 may be configured to penetrate a soil surface 64 of the field and rotate about the respective rotational axis 78 relative to the soil within the field. As the implement 10 is moved across a field, the bearings 80 of each disk gang assembly 44 are typically subject to varying loading conditions as the disks 46 penetrate the soil surface 64 and rotate about the respective rotational axis 78 of the assembly 44, particularly as the disks 46 encounter differing soil conditions and objects within the soil (e.g., rocks, roots, etc.). Such variable loading leads to wear and tear on the bearings 80, which can eventually result in failure of one or more of the bearings 80.

Bearing failure typically occurs over an extended period of time, with the bearing(s) 80 transitioning over time from a normal, fully operational condition to a complete failure condition. During this transition process, the disk gang assembly 44 may be subjected to increased vibrations and loads (e.g., strain), particularly along the shaft assembly 70. For instance, the vibrations/strain transmitted/applied through the shaft assembly 70 (including the gang shaft 72 and the spindles 82) may generally vary as a function of the condition of the bearing(s) 80, with the magnitude of the vibrations/strain increasing relative to an expected threshold/range as the bearing(s) 80 transitions towards complete failure. As such, by monitoring certain parameters associated with the shaft assembly 70 of a given disk gang assembly 44 that vary as a function of the condition of the bearing(s) 80 (e.g., “bearing-related parameters”) during the performance of a tillage operation, it may be inferred or determined when the gang assembly 44 is experiencing a bearing failure condition (including a complete failure condition of one of the bearings 80 and/or a partial failure condition as the bearing(s) 80 transitions between its fully operational condition and its complete failure condition).

In several embodiments, the bearing-related parameter(s) associated with the shaft assembly 70 of a given disk assembly 44 may be monitored using one or more sensors provided in operative association with the shaft assembly 70. For instance, when the monitored bearing-related parameter(s) corresponds to or is associated with the amount or magnitude of vibrations transmitted through one or more components of the shaft assembly 70, the sensor(s) may correspond to any suitable sensor configured to directly or indirectly monitor vibrations, such as an accelerometer, inertial measure unit (IMU), and/or the like. Similarly, when the monitored bearing-related parameter(s) corresponds to or is associated with the amount or magnitude of strain applied through one or more components of the shaft assembly 70, the sensor(s) may correspond to any suitable sensor configured to directly or indirectly monitor strain, such as a strain gauge.

Examples of different types of sensors that can be used to directly or indirectly monitor a bearing-related parameter associated with the shaft assembly 70 of a disk gang assembly 44, including examples of different installation locations for such sensors, are shown in FIG. 3. In one embodiment, one or more vibration sensors 90, such as one or more accelerometers or IMUs, may be used to generate data associated with the amount or magnitude of vibrations transmitted through one or more components of the shaft assembly 70. In such an embodiment, the vibration sensor(s) 90 may be installed at one or more locations along the shaft assembly 70, such as at one or more locations along the shaft 72 and/or within one or more of the spindles 82. For instance, as shown in FIG. 3, a first vibration sensor 90A may be positioned within the spindle 82 located closest or adjacent to the first bearing 80A to monitor vibrations deriving primarily from the first bearing 80A while a second vibration sensor 90B may be positioned within the spindle 82 located closest or adjacent to the second bearing 80B to monitor vibrations deriving primarily from the second bearing 80B. However, in other embodiments, vibration sensors 90 may be installed within any other spindles 82 of the shaft assembly 70, including the installation of a vibration sensor 90 within each spindle 82 of the shaft assembly. Moreover, as shown in FIG. 3, one or more additional vibration sensors 90C may be positioned on the shaft 72 to monitor vibrations transmitted through the shaft 72. Specifically, in the illustrated embodiment, two vibration sensors 90C are shown as being installed on the shaft 72. However, in other embodiments, any number of vibration sensors may be installed on the shaft, including a single vibration sensor or three or more vibration sensors.

In addition to the vibration sensor(s) 90 (or as an alternative thereto), one or more strain sensors 92 (e.g., one or more strain gauges) may be used to generate data associated with the amount or magnitude of strain applied through one or more components of the shaft assembly 70. In such an embodiment, the strain sensor(s) 90 may be installed at one or more locations along the shaft assembly 70, such as at one or more locations along the shaft 72 and/or within one or more of the spindles 82. For instance, as shown in FIG. 3, strain sensors 92A may be positioned within each spindle 82 (e.g., at a location at or adjacent to each disk 46) to monitor the strain applied therethrough. However, in other embodiments, strain sensors may be installed in less than all of the spindles 82, such as by only installing strain sensors within the spindles 82 located adjacent to the bearings 80. Moreover, as shown in FIG. 3, one or more additional strain sensors 92B may be positioned on the shaft 70 to monitor strain applied through the shaft 70. Specifically, in the illustrated embodiment, two strain sensors 92B are shown as being installed on the shaft 72. However, in other embodiments, any number of strain sensors may be installed on the shaft, including a single strain sensor or three or more strain sensors.

In several embodiments, the monitored bearing-related parameter(s) associated with the shaft assembly 70 of a given disk gang assembly 44 may vary as a function of the ground speed of the implement 10 and/or the penetration depth of the disks 46, and this relationship can be used to establish an expected or baseline parameter range for each shaft assembly 70 at various combinations of speed/depth settings (e.g., via a look-up table and/or algorithm). In such an embodiment, by monitoring one or more relevant bearing-related parameters relative to a corresponding threshold(s) for the expected parameter range associated with the current ground speed and depth setting, it can be inferred or determined when one of the bearings 80 of the disk gang assembly 44 is experiencing a bearing failure condition, such as when the monitored parameter value exceeds a maximum threshold value associated with the expected or baseline range for the bearing-related parameter. For instance, the shaft assembly 70 of a given disk gang assembly 44 may have an expected vibration range or expected strain range at each sensor location at a given ground speed and depth setting. In such instance, when the monitored vibration or strain at a given sensor location falls outside the expected range (e.g., by exceeding a maximum threshold of the range), it may be inferred or determined that one of the bearings 80 of the disk gang assembly 44 is experiencing a bearing failure condition.

In addition to such threshold-based load monitoring (or as an alternative thereto), one or more bearing-related parameter(s) associated with the shaft assembly 70 of a given disk gang assembly 44 can be monitored at two or more different locations along the shaft assembly 70 and subsequently compared to determine or infer a bearing failure condition of one of the bearings 80 of the disk gang assembly 44. For example, it may be desirable to monitor a given bearing-related parameter(s) at both a first sensor location along the shaft assembly 70 that is closer to the first bearing 80A than the second bearing 80B (e.g., by placing the associated sensor at or adjacent to the first bearing 80A, such as at the locations of sensors 90A, 92A, 92B adjacent to the first bearing 80A) and a second sensor location along the shaft assembly 70 that is closer to the second sensor 80B than the first bearing 80A (e.g., by placing the associated sensor at or adjacent to the second bearing 80B, such as at the locations of sensor 90B, 92A, 92B adjacent to the second bearing 80B). In such an embodiment, it may generally be expected that the monitored parameter(s) at the first and second sensor locations will generally be similar (e.g., within a given range) when both bearings 80 are operating normally. Thus, an expected or baseline differential range may be established for the monitored parameter(s) that can be used to identify when one of the bearings 80 of the disk gang assembly 44 is likely experiencing a bearing failure condition. In such an embodiment, when the differential in the monitored parameter(s) between the two sensor locations falls outside the expected or baseline differential range, it may be inferred that one of the bearings 80 of the disk gang assembly 44 is experiencing a bearing failure condition. The individually monitored parameter at each sensor location may then be analyzed to identify which bearing 80 is likely experiencing the bearing failure condition. For instance, if the monitored parameter at the first sensor location has experienced an increase in magnitude (e.g., over a given period of time), it may be inferred that the bearing 80 closest to that sensor location (e.g., the first bearing 80A) is likely experiencing a bearing failure condition, particularly if the monitored parameter at the first sensor location has increased over time in a manner that would be indicative of the associated bearing 80 transitioning from its fully operational state or condition to a complete failure state or condition.

It should be appreciated that, in addition to detecting or inferring bearing failure conditions, the monitored bearing-related parameter(s) may also be used to detect or infer disk failure conditions, including bent or broken discs 46 or missing discs 46. For instance, when one of the disks 46 is bent or broken, the amount of vibrations and strain transmitted/applied through adjacent components of the shaft assembly 40 will generally vary relative to an expected or threshold range (e.g., by exceeding a maximum threshold value associated with the range), thereby providing an indication that the disk 46 is bent or broken. Similarly, when one of the disks 46 has completely broken off or is otherwise missing, the amount of vibrations and strain transmitted/applied through adjacent components of the shaft assembly 40 will vary relative to an expected or threshold range (e.g., by dropping below a minimum threshold value associated with the range), thereby providing an indication that the disk 46 is no longer present on the disk gang assembly 44.

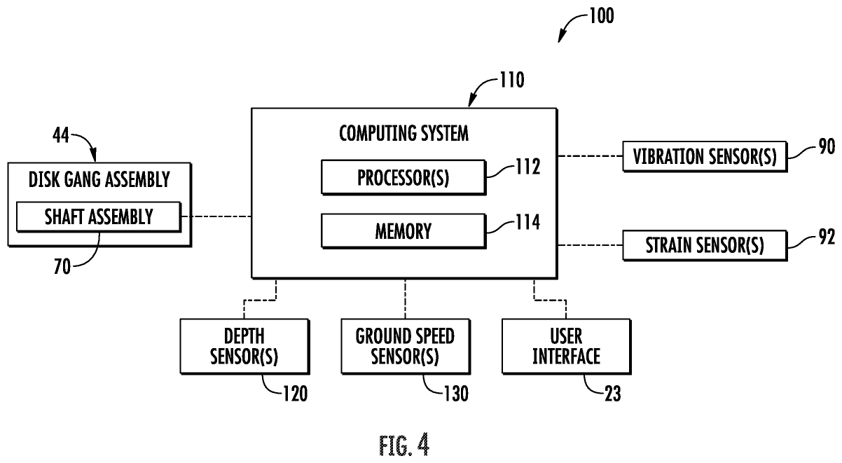

Referring now to FIG. 4, a schematic view of one embodiment of a system 100 for detecting bearing failures of disk gang assemblies of an agricultural implement is illustrated in accordance with aspects of the present subject matter. In general, the system 100 will be described herein with reference to the implement 10 and related disk gang assemblies 44 described above with reference to FIGS. 1-3. However, it should be appreciated by those of ordinary skill in the art that the disclosed system 100 may generally be utilized with agricultural implements having any other suitable implement configuration and/or with disk gang assemblies having any other suitable gang configuration. Additionally, although the system 100 will generally be described with reference to disk gang assemblies, the system 100 may generally be used to detect bearing failures associated with any other tool assemblies that include or incorporate bearings, such as basket assemblies, leveler disk assemblies, and/or any other suitable rotating tool assemblies.

In general, the system 100 may include one or more components of an agricultural implement, such as one or more of the components of the implement 10 described above. For example, as shown in FIG. 4, the system 100 may include one or more disk gang assemblies 44, such as one or more of the front disk gang assemblies 44AL, 44AR and/or one or more of the rear disk gang assemblies 44BL, 44BR of the implement 10. Each disk gang assembly 44 may generally include a shaft assembly 70 (e.g., including a gang shaft 72, bearings 80, and spindles 82) configured to rotationally support the disks 46 at spaced apart locations. As indicated above, each shaft assembly 70 may generally be provided in operative association with one or more sensors (e.g., the sensors 90, 92 described above) configured to provide data indicative of one or more bearing-related parameters associated with the shaft assembly 70, such as the amount or magnitude of the vibrations and/or strain transmitted/applied through the shaft assembly 79.

In accordance with aspects of the present subject matter, the system 100 may also include a computing system 110 configured to execute various computer-implemented functions. In general, the computing system 110 may comprise any suitable processor-based device known in the art, such as a computing device or any suitable combination of computing devices. Thus, in several embodiments, the computing system 110 may include one or more processor(s) 112 and associated memory device(s) 114 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 114 of the computing system 110 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 114 may generally be configured to store suitable computer-readable instructions that, when implemented by the processor(s) 112, configure the computing system 110 to perform various computer-implemented functions, such as one or more aspects of the methods or algorithms described herein. In addition, the computing system 110 may also include various other suitable components, such as a communications circuit or module, one or more input/output channels, a data/control bus and/or the like.

It should be appreciated that the computing system 110 may correspond to an existing computing system of the implement 10 or associated work vehicle 12 or the computing system 110 may correspond to a separate computing system. For instance, in one embodiment, the computing system 110 may form all or part of a separate plug-in module that may be installed in association with the implement 10 or work vehicle 12 to allow for the disclosed system 100 and related methods to be implemented without requiring additional software to be uploaded onto existing computing systems of the implement 10 and/or the work vehicle 12.

In several embodiments, the computing system 110 may be configured to monitor one or more bearing-related parameters associated with the shaft assembly 70 of a given disk gang assembly 44 (e.g., vibration-related and/or strain-related parameters) relative to a corresponding threshold (e.g., a corresponding vibration and/or strain threshold). Specifically, in one embodiment, the computing system 110 may be communicatively coupled to the sensors 90, 92 (e.g., via a wired or wireless connection) to allow the bearing-related parameter(s) to be monitored. The monitored parameter may then be compared to the associated threshold (e.g., selected based on the current ground speed of the implement 10 and the current depth setting of the disks 46) to determine or infer whether the corresponding gang assembly 44 is currently experiencing a bearing failure condition.

For example, in one embodiment, the parameter threshold may correspond to a maximum threshold (e.g., a maximum vibration or strain threshold) for an anticipated or expected range for the shaft assembly 70 (e.g., an expected vibration or strain range) given the current ground speed of the implement 10 and the current depth setting of the disks 46. In such an embodiment, the computing system 110 may be configured to determine or infer that the bearings 80 of the corresponding disk gang assembly 44 are in an acceptable operating state when the monitored parameter is at or below the maximum threshold and that the disk gang assembly 44 is experiencing a bearing failure condition when the monitored parameter exceeds the maximum threshold. In another embodiment, the parameter threshold may form part of a predetermined differential range associated with an anticipated or expected differential range between the individually monitored parameters of separate bearings 80 of a given disk gang assembly 44. In such an embodiment, the computing system 110 may be configured to determine or infer that the bearing 80 subject to an increase in the monitored parameter relative to the other bearing 80 is likely experiencing a bearing failure condition when the differential in the monitored parameter between the two bearings 80 exceeds the predetermined load differential range.

As indicated above, the applicable parameter threshold (and/or parameter differential range) selected for evaluating the operational status of the bearings 80 of a disk gang assembly 44 may generally vary as a function of ground speed and disk penetration depth. Thus, in several embodiments, the computing system 110 may be configured to calculate or select an applicable threshold value (and/or differential range) based on the current ground speed of the implement 10 and the current penetration depth of the disks 46. To account for variations in the ground speed and/or the penetration depth, the computing system 110 may be configured to utilize one or more look-up tables and/or mathematical relationships to select an appropriate threshold (and/or differential range). For instance, in one embodiment, the computing system 110 may include a look-up table or mathematical relationship that correlates threshold values for the threshold (and/or differential ranges) to the ground speed of the implement 10, thereby allowing the computing system 110 to select an initial threshold value (and/or differential range) based on the current ground speed of the implement 10. Such initial threshold value (and/or differential range) may then be adjusted or corrected (e.g., up or down), as necessary, based on the current penetration depth of the disks 46 (e.g., by scaling or adjusting the initial value/range based on a known relationship between the penetration depth and the threshold values/ranges). In another embodiment, the computing system 110 may include a plurality of ground-speed-dependent look-up tables or mathematical relationships (e.g., one for each of a plurality of different ground speeds) that correlates threshold values for the parameter threshold (and/or differential range) to penetration depths of the disks 46 at each ground speed, thereby allowing the computing system 110 to select an appropriate threshold value/range as a function of the penetration depth and ground speed. In such an embodiment, the computing system 110 may be configured to use suitable interpolation techniques to calculate a threshold value/range when the current ground speed is between two reference ground speeds for which look-up tables and/or mathematical expressions are stored within the computing system's memory 114.

Referring still to FIG. 4, to select the applicable parameter threshold and/or differential range, the computing system 110 may generally be configured to receive an input associated with the current penetration depth of the disks 46. In one embodiment, this input may be received from the operator. For instance, the operator may select or input the desired or current penetration depth setting via the user interface 23 provided within the cab 22 of the work vehicle 12. Alternatively, the computing system 110 may be configured to actively monitor the current penetration depth of the disks 46 via sensor feedback provided by one or more depth sensors 120. For example, in one embodiment, each depth sensor(s) 120 may correspond to a pressure sensor or position sensor provided in operative association with a corresponding disk gang actuator(s) (not shown) of the implement 10. In such an embodiment, the sensor(s) may be configured to monitor the extent to which the actuator(s) has been extended/retracted, thereby allowing the computing system 110 to determine or infer the penetration depth of the disks 46 based on the extended/retracted state of the actuator(s). In another embodiment, each depth sensor(s) 120 may correspond to a position sensor (e.g., a rotary or linear potentiometer) configured to monitor the relative position between the toolbar 48 of the corresponding disk gang assembly 44 and the implement's main frame 28, thereby allowing the computing system 110 to determine or infer the penetration depth of the disks 46 based on such position data. In even further embodiments, the computing system 110 may be communicatively coupled to any other suitable depth sensor(s) or feedback device(s) that allows the computing system 110 to directly or indirectly monitor/infer the penetration depth of the disks 46.

Additionally, as shown in FIG. 4, to allow the computing system 110 to monitor the ground speed of the implement 10, the computing system 110 may be communicatively coupled to one or more ground speed sensors 130. In general, the ground speed sensor(s) 130 may correspond to any suitable sensing device or system that is configured to provide data indicative of the ground speed of the implement 10. For instance, in one embodiment, the ground speed sensor 130 may correspond to a GPS device or any other suitable satellite navigation position system configured to generate data associated with the ground speed of the implement 10. In another embodiment, the ground speed sensor(s) 130 may correspond to a rotary speed sensor(s) configured to monitor the rotational speed of a given component that provides an indication of the ground speed of the implement 10, such as the engine 24 or transmission 26 of the work vehicle 12 or a wheel of the vehicle 12 or implement 10.

It should be appreciated that, in several embodiments, the specific parameter threshold value selected for a given disk gang assembly 44 may differ from the threshold value selected for a different disk gang assembly 44 of the implement 10. Specifically, in many instances, the vibrations/strain associated with the rear disk gang assemblies 44B may differ from the vibrations/strain associated with the front disk gang assemblies 44A independent of ground speed and penetration depth. As such, the threshold selected for the front disk gang assemblies 44A (e.g., the max vibration/strain threshold or the vibration/strain differential threshold) may differ from the threshold selected for the rear disk gang assemblies 44B (e.g., the max vibration/strain threshold or the vibration/strain differential threshold) to accommodate the expected or anticipated difference in the monitored bearing-related parameters between such gang assemblies.

As indicated above, when one of the bearings 80 of a given disk gang assembly 44 begins to experience a bearing failure condition, the monitored bearing-related parameter associated with the corresponding shaft assembly 70 will generally vary relative to an expected threshold or range of such monitored parameter. For instance, as the condition of one of the bearings 80 begins to degrade over time, the amount or magnitude of the vibrations and/or strain transmitted/applied through adjacent portions of the shaft assembly 70 will increase over time as a function of the bearing degradation. Thus, by monitoring the bearing-related parameter relative to a threshold or range that been selected based on the expected parameter values for functional or non-failing bearings 80, the computing system 110 may infer or determine when one of the bearings 80 is experiencing a bearing failure condition.

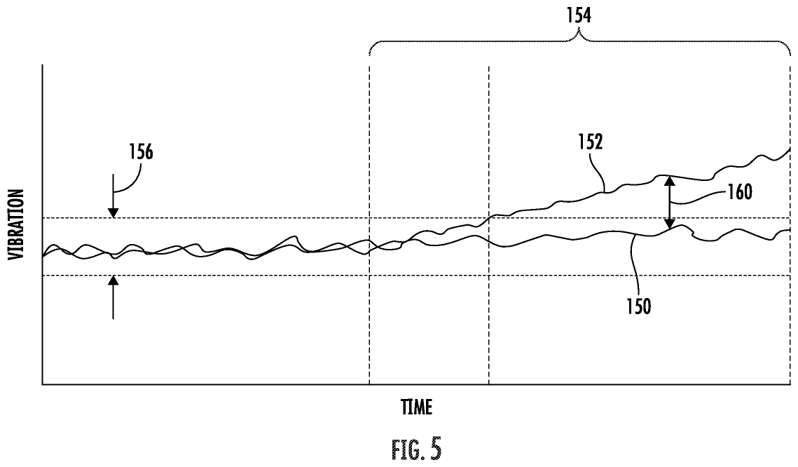

Referring briefly to FIG. 5, an example data plot showing the monitored vibration transmitted through a shaft assembly 70 over a given period of time is illustrated in accordance with aspects of the present subject matter, with line 150 showing the data trace for a sensor location along the shaft assembly 70 positioned adjacent to the first bearing 80A (e.g., the location of sensor 90A in FIG. 3) and line 152 showing the data trace for a sensor location along the shaft assembly 70 positioned adjacent to the second bearing 80B (e.g., the location of sensor 90B in FIG. 3). In particular, FIG. 5 shows an instance in which the second bearing 80B is experiencing a bearing failure condition. As indicated above, bearing failures typically occur over an extended period of time as the failing bearing(s) 80 transitions from a fully operational condition to a complete failure condition. During such transition, the adjacent portion(s) the shaft assembly 70 will typically experience a gradual or steady increase in the vibrations transmitted through the shaft assembly 70 over the applicable time period. For instance, in the illustrated embodiment, the vibrations transmitted through the shaft assembly at the sensor location adjacent the second bearing 80B (i.e., line 152) steadily increase over a bearing failure period 154 (e.g., from time to to time t2) as the bearing 80B transitions from the fully operational condition to the complete failure condition.

As indicated above, to detect such bearing failure, different detection methodologies may be employed (either individually or in combination). For instance, each shaft assembly 70 may have an anticipated or expected parameter range given the current ground speed of the implement 10 and the current depth setting of the disks 46, such as an expected vibration range 156 for the shaft assembly 70. The expected vibration range generally provides minimum and maximum thresholds between which the vibrations transmitted through the shaft assembly 70 are generally expected to be maintained during the execution of an associated field operation (e.g., a tillage operation). As such, when it is detected that the vibrations transmitted through the shaft assembly 70 have exceeded the maximum vibration threshold associated with the expected vibration range for such shaft assembly, it may be determined that at least one bearing of the shaft assembly is experiencing a bearing failure condition, particularly if the vibrations continue to remain above the maximum vibrations threshold. For instance, as shown in FIG. 5, the vibrations transmitted through the shaft assembly 70 exceeded the maximum vibration threshold associated with the respective expected vibration range 156 at a given time (t₁) and then remained above such threshold for the remainder of the bearing failure period 154. Specifically, consistent with a bearing failure condition, the average vibrations transmitted through the shaft assembly 70 continued to steadily increase from time t₁ as the associated bearing 80A further transitioned towards the complete failure condition (e.g., at time t2).

In addition to such individual threshold-based determinations (or as an alternative thereto), the bearing failure for a disk gang assembly 44 may also be detected by determining a differential between the monitored bearing-related parameters across the associated shaft assembly 70 (e.g., at spaced apart sensor locations along the shaft assembly 70) and comparing such differential to a predetermined differential range selected for the shaft assembly 70. For instance, in the illustrated embodiment, a differential 160 between the monitored vibrations may be continuously monitored and compared to an associated maximum vibration differential value for the shaft assembly 70. When it is determined that the monitored differential 160 exceeds the associated maximum differential value, it may be inferred that one of the bearings 80 of the shaft assembly 70 is experiencing a bearing failure condition. The individual vibration data associated with each sensor location (e.g., lines 150, 152) may then be analyzed to identify which bearing 80 is likely experiencing the bearing failure condition. For example, in the illustrated embodiment, despite both sensor locations experiencing an increase in vibrations over time period 154, the increase in the monitored differential 160 is due primarily to the increase in the vibrations at the sensor location 152 positioned closest to the second bearing 80B, thereby indicating that such bearing 80B is likely experiencing the bearing failure condition.

Referring back to FIG. 4, as indicated above, the computing system 110 may be configured to monitor a bearing-related parameter associated with a shaft assembly 70 of a disk gang assembly 44 to when one of the bearings 80 of such gang assembly 44 is experiencing a bearing failure condition. Moreover, when it is determined that a bearing 80 of a given disk gang assembly 44 is experiencing a bearing failure condition, the computing system 110 may be further configured to automatically initiate one or more control actions. For example, the computing system 110 may be configured to provide the operator with a notification that the bearing 80 of a disk gang assembly 44 is experiencing a bearing failure condition. Specifically, in one embodiment, the computing system 110 may be communicatively coupled to the user interface 23 of the work vehicle 12 via a wired or wireless connection to allow notification signals to be transmitted from the computing system 100 to the user interface 23. In such an embodiment, the notification signals may cause the user interface 23 to present a notification to the operator (e.g., by causing a visual or audible notification or indicator to be presented to the operator) which provides an indication that a bearing of a given disk gang assembly is experiencing a bearing failure condition. In such instance, the operator may then choose to initiate any suitable corrective action he/she believes is necessary, such as adjusting the ground speed of the implement 10 (including bringing the implement to a stop).

Additionally, in several embodiments, the control action(s) executed by the computing system 110 may include automatically adjusting the operation of the implement 10 and/or the associated work vehicle 12. For instance, in one embodiment, the computing system 110 may be configured to automatically adjust the ground speed of the implement 10 to address the identified bearing failure condition, such as by actively controlling the engine 24 and/or the transmission 26 of the work vehicle 12 to safely bring the vehicle/implement to a stop.

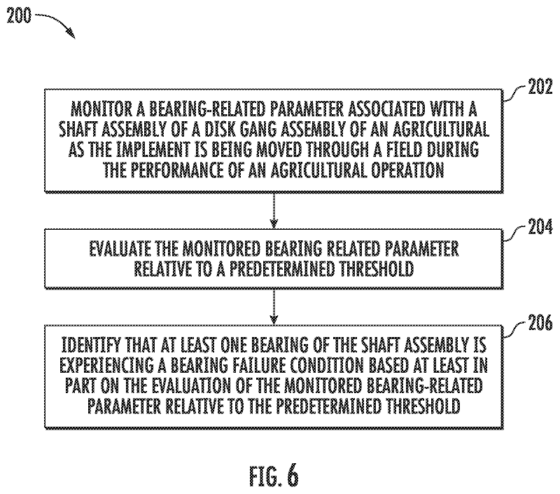

Referring now to FIG. 6, a flow diagram of one embodiment of a method 200 for detecting bearing failures for a disk gang assembly of an agricultural implement is illustrated in accordance with aspects of the present subject matter. In general, the method 200 will be described herein with reference to the agricultural implement 10, disk gang assemblies 44, and system 100 described above with reference to FIGS. 1-4. However, it should be appreciated by those of ordinary skill in the art that the disclosed method 200 may generally be utilized in association with agricultural implements having any suitable implement configuration, tool assemblies having any other suitable tool configuration and/or systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 may include monitoring a bearing-related parameter associated with a shaft assembly of a disk gang assembly of an agricultural as the implement is being moved through a field during the performance of an agricultural operation. For instance, as indicated above, the computing system 110 may be communicatively coupled to one or more sensors 90, 92 configured to generate data indicative of a bearing-related parameter associated with a shaft assembly 70 of a given disk gang assembly 44, such as data indicative of the vibrations and/or strain transmitted/applied through the shaft assembly 70. By receiving the data from the associated sensor(s) 90, 92, the computing system 110 may be configured to monitor the bearing-related parameter associated with the shaft assembly 70.

Additionally, at (204), the method 200 may include evaluating the monitored bearing-related parameter relative to a predetermined threshold. As described above, the computing system 110 may be configured to evaluate the monitored parameter relative to an associated threshold. For instance, in one embodiment, the monitored parameter may be evaluated relative to a maximum parameter threshold selected for the shaft assembly (e.g., a maximum vibration threshold or a maximum strain threshold). Alternatively, the monitored parameter may be used to determine a parameter differential between spaced apart sensor locations along the shaft assembly 70, which may then be evaluated relative to an associated load differential threshold(s) for the shaft assembly 70.

Moreover, at (206), the method 200 may include identifying that at least one bearing of the shaft assembly is experiencing a bearing failure condition based at least in part on the evaluation of the monitored bearing-related parameter relative to the predetermined threshold. For instance, when the threshold corresponds to a maximum threshold, the computing system 110 may be configured to identify that a bearing(s) is experiencing a bearing failure condition when the monitored parameter exceeds the maximum threshold. Alternatively, when the threshold corresponds to a differential threshold associated with a predetermined differential range, the computing system 110 may be configured to identify that a bearing(s) is experiencing a bearing failure condition when the monitored differential falls outside the corresponding differential range and such event occurs as a result in an increase in the monitored parameter at one of the sensor locations (e.g., an increase over a given period of time).

It is to be understood that the steps of the method 200 are performed by the computing system 110 upon receiving a vibratory parameter and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 110 described herein, such as the method 200, is implemented in software code or instructions which are tangibly stored on a tangible computer readable medium. The computing system 110 loads the software code or instructions via a direct interface with the computer readable medium or via a wired and/or wireless network. Upon loading and executing such software code or instructions by the computing system 110, the computing system 110 may perform any of the functionality of the computing system 110 described herein, including any steps of the method 200 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for detecting bearing failures for disk gang assemblies of an agricultural implement, the system comprising:
a disk gang assembly comprising:
a shaft assembly including a shaft and at least one bearing rotatably supporting the shaft for rotation about a rotational axis;
a plurality of disks supported on the shaft for rotation therewith about the rotational axis;
a sensor provided in operative association with the shaft assembly, the sensor being configured to generate data indicative of a bearing-related parameter associated with the shaft assembly; and
a computing system communicatively coupled to the sensor, the computing system being configured to:
monitor the bearing-related parameter associated with the shaft assembly based at least in part on the data received from the sensor; and
identify that the at least one bearing is experiencing a bearing failure condition based at least in part on an evaluation of the monitored bearing-related parameter.

2. The system of claim 1, wherein the computing system is configured to evaluate the monitored bearing-related parameter associated with the shaft assembly relative to a parameter threshold defined for the bearing-related parameter and identify that the at least one bearing is experiencing the bearing failure condition based at least in part on the evaluation of the monitored bearing-related parameter relative to the parameter threshold.

3. The system of claim 2, wherein the parameter threshold comprises a maximum parameter threshold, the computing system being configured to identify that the at least one bearing is experiencing the bearing failure condition when the monitored bearing-related parameter exceeds the maximum parameter threshold.

4. The system of claim 1, wherein:
the at least one bearing comprises first and second bearings positioned at spaced-apart locations relative to the shaft assembly;
the sensor is a first sensor and the system further comprises a second sensor configured to generate data indicative of the bearing-related parameter associated with the shaft assembly; and
the first sensor is positioned closer to the first bearing along the shaft assembly and the second sensor is positioned closed to the second bearing along the shaft assembly.

5. The system of claim 4, wherein the computing system is configured to calculate a parameter differential between a first parameter value for the bearing-related parameter determined based on the data received from the first sensor and a second parameter value for the bearing-related parameter determined based on the data received from the second sensor.

6. The system of claim 5, wherein the computing system is configured to identify that one of the first bearing or the second bearing is experiencing the bearing failure condition based at least in part on the parameter differential.

7. The system of claim 1, wherein the bearing-related parameter is associated with vibrations transmitted through at least a portion of the shaft assembly.

8. The system of claim 1, wherein the bearing-related parameter is associated with strain applied through at least a portion of the shaft assembly.

9. The system of claim 1, wherein the sensor is installed on the shaft of the shaft assembly.

10. The system of claim 1, wherein the shaft assembly further includes a plurality of spindles spaced apart along the shaft, the sensor being installed within one of the plurality of spindles.

11. A method for detecting bearing failures for a disk gang assembly of an agricultural implement, the method comprising:
monitoring, with a computing system, a bearing-related parameter associated with a shaft assembly of the disk gang assembly as the agricultural implement is being moved through a field during the performance of an agricultural operation;
evaluating, with the computing system, the monitored bearing-related parameter relative to a predetermined threshold; and
identifying, with the computing system, that at least one bearing of the shaft assembly is experiencing a bearing failure condition based at least in part on the evaluation of the monitored bearing-related parameter relative to the predetermined threshold.

12. The method of claim 11, wherein the predetermined threshold comprises a maximum threshold, and wherein identifying that the at least one bearing is experiencing the bearing failure condition comprises identifying that the at least one bearing is experiencing the bearing failure condition when the monitored bearing-related parameter exceeds the maximum threshold.

13. The method of claim 11, wherein:
the at least one bearing comprises first and second bearings positioned at spaced-apart locations relative to the shaft assembly; and
monitoring the bearing-related parameter comprises monitoring the bearing related parameter at both a first sensor location positioned closer to the first bearing along the shaft assembly and a second sensor location positioned closer to the second bearing along the shaft assembly.

14. The method of claim 13, wherein the method further comprises calculating a parameter differential between a first parameter value for the bearing-related parameter determined based on data associated with the first sensor location and a second parameter value for the bearing-related parameter determined based on data associated with the second sensor location.

15. The method of claim 14, wherein evaluating the monitored bearing-related parameter relative to the predetermined threshold comprises comparing the parameter differential to the predetermined differential threshold and wherein identifying that the at least one bearing is experiencing the bearing failure condition comprises identifying that one of the first bearing or the second bearing is experiencing the bearing failure condition based at least in part on the parameter differential.

16. The method of claim 11, further comprising initiating a control action when it is determined that the at least one bearing is experiencing the bearing failure condition.

17. The method of claim 16, wherein initiating the control action comprises generating an operator notification.

18. The method of claim 16, wherein initiating the control action comprises automatically controlling an operation of the agricultural implement.

19. The method of claim 11, wherein monitoring the bearing-related parameter comprises monitoring a parameter associated with vibrations transmitted through at least a portion of the shaft assembly.

20. The method of claim 11, wherein monitoring the bearing-related parameter comprises monitoring a parameter associated with strain applied through at least a portion of the shaft assembly.
